(19) United States
(12) Patent Application Publication
(10) Pub. No.: US 2012/0210070 A1
(43) Pub. Date: Aug. 16, 2012

(54) NON-BLOCKING DATA MOVE DESIGN

(75) Inventors: Michael A. Blake, Wappingers Falls, NY (US); Timothy C. Bronson, Round Rock, TX (US); Pak-kin Mak, Poughkeepsie, NY (US); Craig R. Walters, Highland, NY (US)

(73) Assignee: INTERNATIONAL BUSINESS MACHINES CORPORATION, Armonk, NY (US)

(21) Appl. No.: 13/450,871

(22) Filed: Apr. 19, 2012

Related U.S. Application Data
(63) Continuation of application No. 12/821,963, filed on Jun. 23, 2010.

(51) Int. Cl. G06F 12/08

(52) U.S. Cl. 711/129; 711/E12.022; 711/E12.002

(57) ABSTRACT

A mechanism for data buffering is provided. A portion of a cache is allocated as buffer regions, and another portion of the cache is designated as random access memory (RAM). One of the buffer regions is assigned to a processor. A data block is stored to the one of the buffer regions of the cache according an instruction of the processor. The data block is stored from the one of the buffer regions of the cache to the memory.

This is a continuation application that claims the benefit of U.S. patent application Ser. No. 12/821,963 filed Jun. 23, 2010, the contents of which are incorporated in entirety by reference herein.

### BACKGROUND

Exemplary embodiments relate generally to processing for a cache within a computing environment, and more particularly to allocating a distinct region of the cache for data buffering.

IBM System z® has an architected Move Character Long (MVCL) instruction that copies a storage data block from one memory location to another. Earlier hardware implementations of this MVCL instruction entailed having the processor issue a series of cache line loads for the source and destination addresses into the processor L1 cache and then store the data from the source addresses into the destination addresses. This was time consuming and polluted the small processor L1 caches as the moved data may not be used immediately or to be used by another processor. Recent hardware implementations featured a Data Mover hardware engine in the Nest/Symmetric Multiprocessing (SMP) design for when the source and destination addresses of the MVCL instruction are page address aligned to speed up the move and avoid processor cache pollution by moving data directly between memory via discrete data buffers. But due to the volume of data being moved per instruction this required a lot of hardware resources to buffer the data and to provide data protection until the move completes. Consequently, a restriction was imposed on the number of MVCLs which can be processed concurrently by different processors in a SMP system, and with the number of processors growing with each new system/generation, overall MVCL performance is being impacted. For those processors executing page-aligned MVCL without available data buffer resources they are therefore “blocked” from being processed.

### BRIEF SUMMARY

An exemplary embodiment is a computer implemented method for data buffering. A portion of a cache is allocated as buffer regions, and another portion of the cache is designated as random access memory (RAM). One of the buffer regions is assigned to a processor. A data block is stored to the one of the buffer regions of the cache according an instruction of the processor. The data block is stored from the one of the buffer regions of the cache to the memory.

Another exemplary embodiment is a computer implemented method for data buffering. A portion of a cache is allocated as buffer regions, and another portion of the cache is designated as random access memory (RAM). Processors are assigned to the buffer regions such that each processor is assigned to its own corresponding buffer region of the buffer regions. Data blocks are simultaneously stored to the corresponding buffer region for each of the processors of the cache according instructions of the processors. The data blocks are stored from the corresponding buffer region of the cache for each of the processors into the memory.

An additional exemplary embodiment is a cache having a data buffering configuration. The cache includes a pipeline and memory elements. The memory elements are configured where a portion of the memory elements is allocated as data buffers and another portion of the memory elements is designated as memory. A controller is configured to assign processors to respective ones of the data buffers. The pipeline is configured to receive instructions from the processors for storing data. The controller is configured to simultaneously store the data for each of the processors into the respective ones of the data buffers. The controller is configured to move the data for each of the processors out of the respective ones of the data buffers into the memory.

A further exemplary embodiment is a cache having a data buffering configuration. Data buffers include memory elements and memory includes memory elements. The data buffers are configured to simultaneously store various data according to instructions from different processors. The data buffers are configured to move the various data for the different processors into the memory.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE SEVERAL VIEWS OF THE DRAWINGS

Referring now to the drawings wherein like elements are numbered alike in the several FIGURES:

FIG. 1 depicts a state of the art cache topology;

FIG. 2 depicts an example of multiple nodes operatively connected to one another;

FIGS. 3A and 3B depict a flow for moving data of MVCL instructions utilizing buffer regions in accordance with exemplary embodiments;

FIG. 4 depicts an example of a conventional node configuration;

FIG. 5 depicts a cache topology in accordance with exemplary embodiments;

FIG. 6 depicts an example of a buffer region in accordance with exemplary embodiments;

FIG. 7 depicts address, control, and data flow in a higher level cache in accordance with exemplary embodiments.

### DETAILED DESCRIPTION

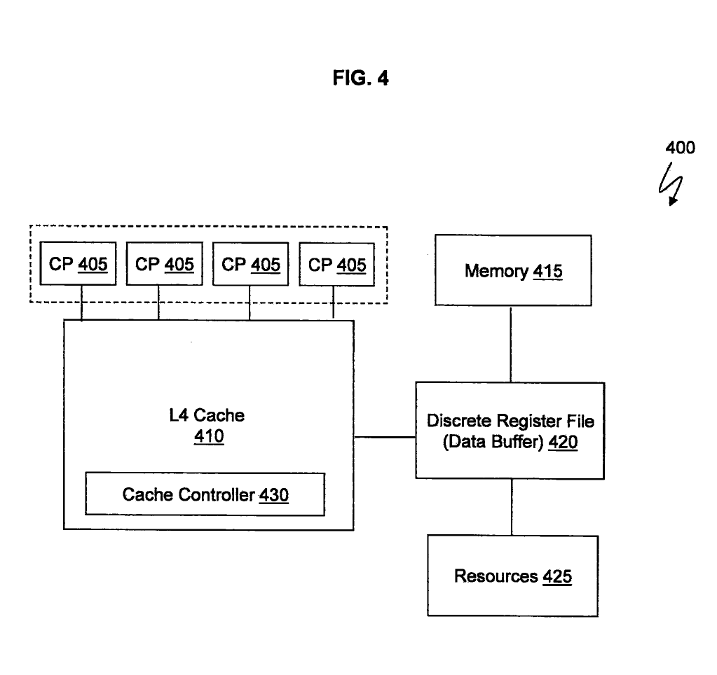

Exemplary embodiments provide a mechanism for a modified cache. For example, exemplary embodiments are configured to reallocate a portion of the cache specifically to be used instead of discrete register files (shown in FIG. 4) for data buffering. Discrete register files only allow one MVCL instruction to be processed at a time because of the physical constraints of hardware. However, exemplary embodiments are configured to allow as many MVCLs to be processed simultaneously as desirable. This disclosure describes the hardware mechanism for creating this distinct cache region for MVCL data buffering and the management controls for the same.

The technical effects include, inter alia, reducing the hardware real estate required for data buffering for a cache and providing multiple (faster) MVCL instruction execution.

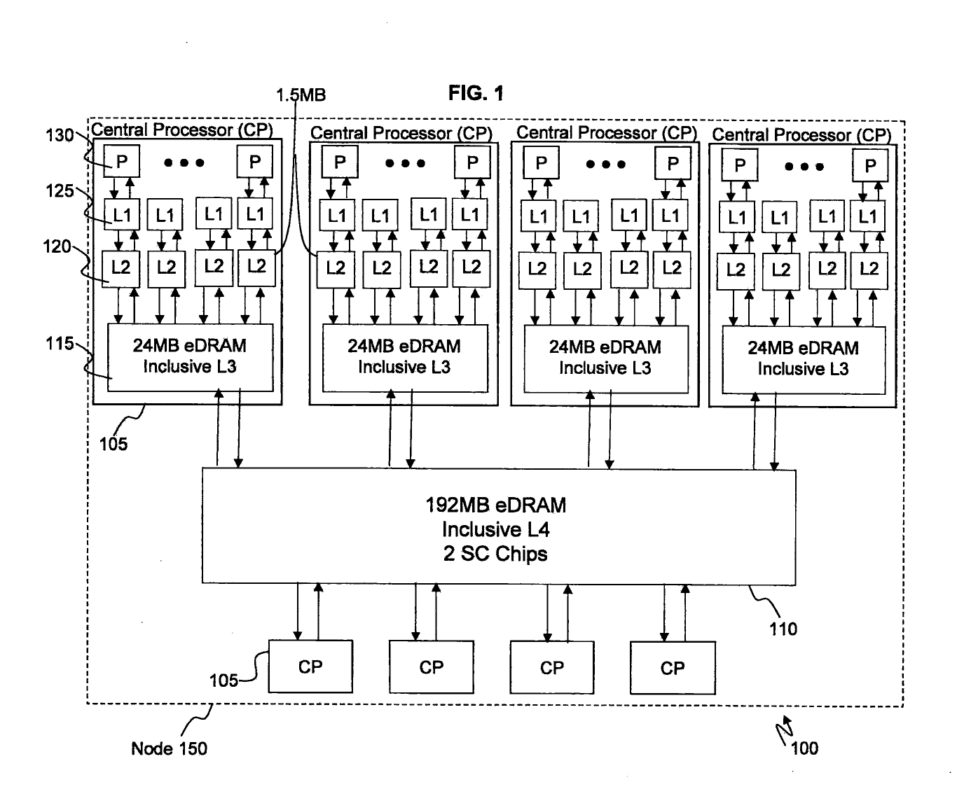

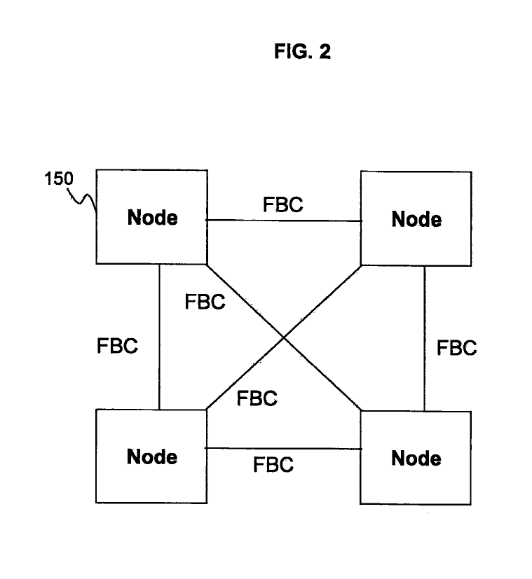

FIG. 1 illustrates a state of the art cache topology 100. FIG. 1 illustrates a plurality of central processor chips (CP) 105 (also referred to as central processing units) operatively connected via busses to one or more L4 caches 110. Each of the central processor chips (CP) 105 includes one or more cores (also referred to as processors) 130 which perform the reading and executing of instructions. On each central processor chip (CP) 105, the multiple processors 130 are operatively connected via busses to the L1, L2, and L3 caches 125, 120, and 115 as understood by one skilled in the art. The L1 caches 125 are physically closest to the cores 130, next are the L2 caches 120, and then the L3 caches 115. It is understood that the designation of caches could be reversed. Although the L3 and L4 caches 115 and 110 may comprise embedded dynamic random access memory (DRAM) which is referred to as eDRAM, it is understood by a skilled artisan that any other types of suitable memory such as SRAM may be utilized. A plurality of central processor chips 105 operatively connected to the L4 caches 110 (e.g., two L4 caches) form a node 150. In a computing system, multiple such nodes 150 may be operatively connected to one another for communicating such as making and responding to requests along with transferring and storing data, as understood by one skilled in the art. FIG. 2 illustrates an example of multiple nodes 150 operatively connected to one another via, e.g., a fabric.

Each individual central processor 105 is fabricated on its own separate chip, which includes the L1, L2, and L3 caches 125, 120, and 115, and the L4 cache 110 is fabricated on its own separate chip. As understood by a skilled artisan, fabrication of chips including integrated circuits, wires, metal layers, semiconductor (and/or other material) components, etc., may be formed via lithography and other techniques. The fabrication process may include various deposition techniques including physical vapor deposition (PVD), chemical vapor deposition (CVD), electrochemical deposition (ECD), molecular beam epitaxy (MBE), and atomic layer deposition (ALD) among others.

Now turning to FIG. 4, FIG. 4 illustrates an example of a conventional node configuration 400. A plurality of central processor chips 405 are connected to an L4 cache 410. The L4 cache 410 includes a cache controller 430 for controlling the cache 410. Memory 415 is connected to the L4 cache 410. A discrete register file 420 is operatively connected to the L4 cache 410 and it comprises one or more data buffers used in prior art to temporarily hold data from and to memory for processing of a single MVCL instruction. It is understood that if the size of the discrete register file 420 is sufficient to operate on 1 MVCL instruction and if each of the processors 130 across the four central processor chips 405 wanted to perform its own MVCL instruction, they could not each simultaneously use the discrete register file 420 but would have to wait in line until a previous processor was complete.

For example, if each of the processors within the central processor chips 405 were to perform respective Move Character Long (MVCL) instructions which copy a storage data block from one memory location to another, such as from memory 415 and/or from other resources 425 to the discrete register file, only one MVCL instruction may be performed at a time. So the first processor 130 could perform a MVCL instruction to copy a storage data block from the memory 415 or resource 425 to the discrete register file 420. After the MVCL instruction copies the storage data block to the discrete register file 420 and after the discrete register file 420 has copied the storage data block to the memory 415 for the first processor 130, then the second processor 130 can perform its MVCL instruction. After the second processor 130 performs the MVCL instruction to copy a storage data block from the memory 415 or resource 425 to the discrete register file 420 and after the discrete register file 420 copies the storage data block to the memory 415, then the third processor 130 can perform its MVCL instruction as discussed above to copy a storage data block into the discrete register file 420 and so forth. After the third processor completes its MVCL instruction, then the fourth processor can perform its MVCL instruction. If there were five, six, seven, eight, or more processors, each would have to wait in line (in series) to execute its respective MVCL instruction to copy a storage data block to the discrete register file 420 because multiple MVCL instructions for copying multiple different storage data blocks cannot be simultaneously performed with the single discrete register file 420 in the node 400.

Even if one considered adding more and more discrete register files 420, a skilled artisan understands that each discrete register file 420 requires physical hardware (e.g., silicon, germanium, metal contacts, etc.) to fabricate the discrete register file 420 and requires physical hardware to fabricate the connections such as the busses that connect the discrete register file 420 to other hardware (such as memory 415 and other resources 425). The discrete register file 420 is fabricated on the L4 cache 410 chip. So if more and more discrete register files 420 are added, then more space on the L4 cache 410 chip is required, which in turn restricts the space for other hardware such as more cache or more controllers. As such, skilled artisans recognize the impracticality of simply adding more and more discrete register files 420, especially when hardware real estate is already scarce.

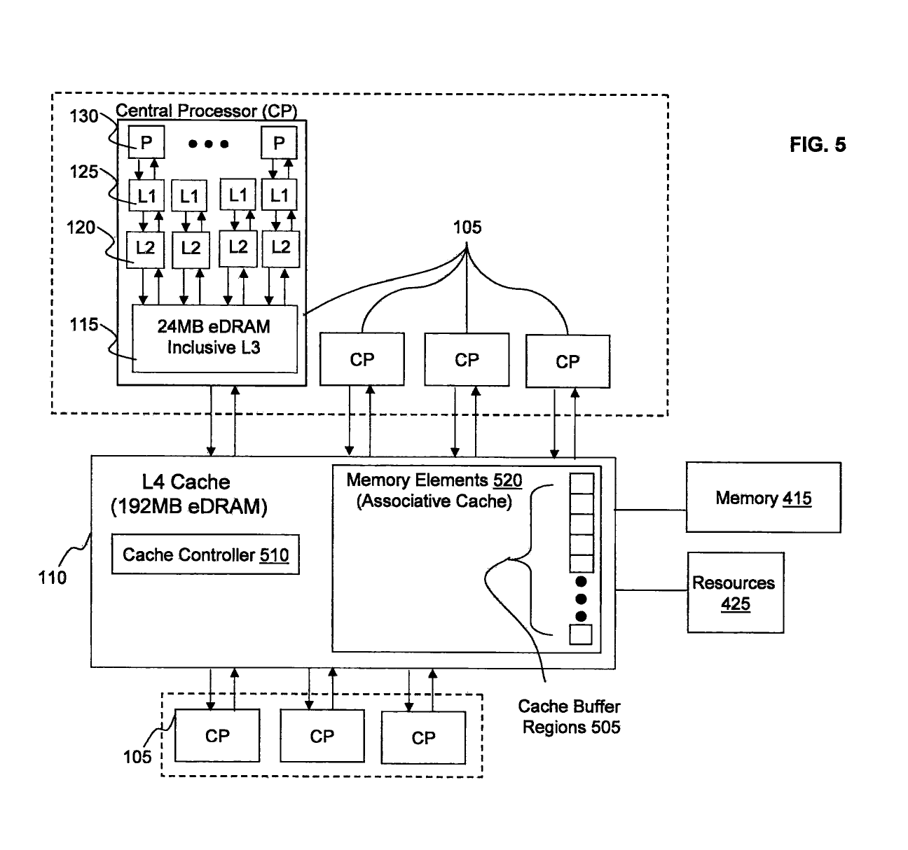

FIG. 5 illustrates the L4 cache 110 chip with cache buffer regions 505 in accordance with exemplary embodiments. The L4 cache 110 includes memory elements 520 (i.e., associative cache) for storing data. A portion of the memory elements 520 are included as buffer regions 505 according to exemplary embodiments. Each individual box represents an individual buffer region 505 on the L4 cache 110. In exemplary embodiments, a portion of the memory (e.g., eDRAM) elements such as particular capacitors of the L4 cache 110 are allocated, assigned, and addressed by a cache controller 510 to be specifically utilized as data buffers of the buffer regions 505. The buffer regions 505 are part of the L4 cache 110 itself and are on the L4 cache 110 chip. Unlike the discrete register file 420, the reallocation and assignment of a portion of the L4 cache 110 to be utilized as the buffer regions 505 does not require the fabrication of separate distinct elements, e.g., such as wires as connectors, silicon components, metal contacts, etc., as the discrete register file 420 requires. As such, additional memory elements 520 and/or cache controllers 510 may be added in each L4 cache 110 in place of the connections (wire busses) to and from the discrete register file 420 and in place of the physical hardware that constitutes the discrete register file 420.

In accordance with exemplary embodiments, each processor 130 has its own respective buffer region 505 (represented by the individual boxes). Each individual buffer region 505 is assigned to one of the processors 130 by the cache controller 510 until all the processors 130 are assigned to their own buffer region 505. So if there are twenty-four processors 130, then L4 cache 110 would have twenty-four separately addressable (boxes) buffer regions 505 each corresponding to one of the twenty-four processors 130. Accordingly, each processor 130 can simultaneously perform its own MVCL instruction to move a storage data block (e.g., 4 KB (kilobyte) data page) from main memory 415 and/or resources 425 (which may be other caches in other nodes 120, external memory, removeable memory, etc.) to their own respective buffer region 505 on the L4 cache 110, without having to buffer data in the discrete register file 420 of FIG. 4. Also, the processors 130 do not have to wait in line for a previous processor 130 to finish utilizing the buffer region 505. For example, twenty-four processors 130 can each simultaneously move their respective storage data blocks from memory 415 to their respective buffer regions 505 at the same time without having to wait in line to buffer their storage data blocks. The on-chip storage data blocks can then be moved (stored) from the respective buffer regions 505 into the memory 415. Note that buffer regions 505 are memory elements 520 of the L4 cache 110 that are restricted from use in normal caching; normal caching techniques are understood by one skilled in the art. The buffer regions 505 are able to leverage existing connections of the L4 cache 110, such as existing busses to and from memory 415 and/or cache controller 510 already in place for the L4 cache 110. Also, the buffer regions 505 leverage the existing internal structure (including controllers, addresses, data buffers, busses, etc.) of the L4 cache 110 which operatively connects memory elements to other memory elements (e.g., capacitors to capacitors), along with their respective power sources and connections.

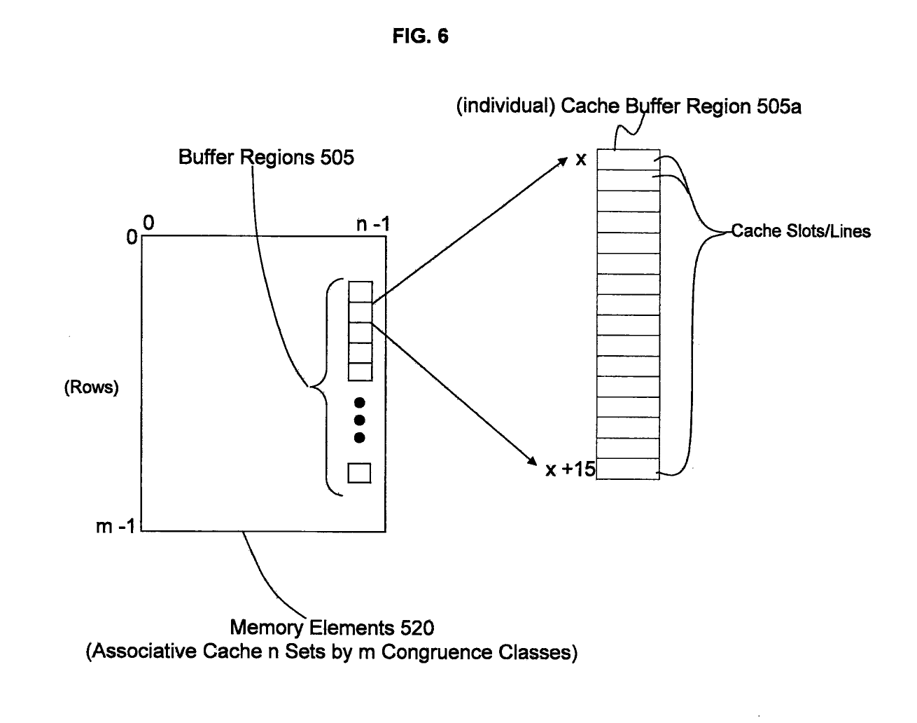

For illustrative purposes and not limitation, FIG. 6 illustrates an example of the MVCL buffer region 505 in an associative cache in accordance with exemplary embodiments. Each individual (box) buffer region 505 has a size of 4 KB and cache line size of 256 B. For example, FIG. 6 depicts an implementation of the L4 cache 110 having a plurality of buffer regions 505. An individual buffer region of the buffer region 505 is designated as buffer region 505a for illustration. For ease of understanding, details of one buffer region 505a may be discussed at times but apply to each of the buffer regions 505. As seen in the buffer region 505a, there are 16 cache lines/slots which make up a (4 KB data) page. The # number of cache lines in a page=4 KB/256 B which equals 16 because each cache line is 256 B.

As an example, assume that the L4 cache 110 is a 192 MB (megabyte) cache. So for a 192 MB cache with 24 sets, the # number of congruence classes=32768.

In the L4 cache 110, the following provides an example with regard to system address mapping for 64-bit addressing:

address bits 0:63=System Byte address,

address bits 0:55=cache line address,

address bits 0:51=System Page address, and

address bits 41:55=Congruence Class Address Range (CCAR).

In accordance with exemplary embodiments, the following describes an example of addressing for the MVCL buffer region 505:

CCAR 52:55=16 cache lines of the 4 KB page, and

CCAR 41:51=address index for up to 2,048 (individual) MVCL Buffer regions 505. CCAR 41:51 represents the address index range within which each of the 24 buffer regions 505 reside.

Note that only 1 MVCL buffer region 505a per processor 130 is necessary. However, in some implementations of exemplary embodiments, a designer may desire that two processors 130 share a buffer region 505a. Also, implementations may allow two, three, four, and/or five processors 130 to share a buffer region 505a and/or multiple buffer regions 505. For example, four processors 130 may share three different buffer regions 505 on a first come first served basis. Also, the allocation of buffer regions 505 to different processors 130 may be configured dynamically as processors 130 are configured dynamically into an existing system.

Further in accordance with exemplary embodiments, the buffer regions 505 can be allocated/designated (e.g., via basic input/output system (BIOS)) during boot-up of the computer system in which the L4 cache 110 is housed. Also, the buffer regions 505 can be set up by firmware during system power-on initialization, which may be firmware of the cache controller 510. Via the cache controller 510, the buffer regions 505 would be restricted and off limits to normal caching for the L4 cache 110, and buffer regions 505 would be delineated as individual data buffers for their respective processors 130.

The MVCL instruction has a length specification of up to 16 MB and/or maybe more. A 4 KB page length for the Data Mover was determined as a beneficial size but lengths greater than a 4 KB page may be utilized. On move lengths that are much greater than 4 KB, a particular processor 130 will loop through (the L4 cache 110) 4 KB at a time until all the data (storage blocks) is moved into the buffer region 505 and then into memory. Although lower level caches (such as the L3 cache 115 and L2 cache 120) can implement exemplary embodiments, the highest level cache (one that is closest to memory and largest) may be considered best suited to hold the MVCL buffer region 505 but exemplary embodiments are not meant to be limited to the same. Additionally, although discussion refers to the L4 cache 110 which is a shared cache, exemplary embodiments are not limited to a shared cache but can be utilized in a private cache as well.

As one example implementation in accordance with exemplary embodiments, on IBM System z® (e.g, zGryphon), the L4 cache (such as the L4 cache 110) is the highest level cache closest to memory (e.g., memory 415) and it is a 192 MB node level cache shared by up to 24 processors 130. Up to 24 4 KB pages or 96 KB can be allocated for the MVCL buffer regions 505. The buffer regions 505 (e.g., totaling 96 KB) only occupy 1/2000th of the L4 cache 110, which is not noticeable from cache performance perspective. However, 96 KB would be costly (from a chip die size yield perspective as well as a hardware real estate perspective) if built using regular register files 420.

The cache controller 510 is configured to utilize a special cache directory tag value for each cache entry (e.g., each buffer region 505a) that is part of the MVCL buffer region 505. The directory tag normally indicates the cache entry validity state, ownership state, and processor ownership. By the cache controller 510, the special directory tag additionally denotes a non-system address cache entry, and the special directory tag also denotes a non-LRU (least recently used) selectable entry for eviction on a storage access with a cache miss. Also, in order to make room for a new entry on a cache miss, the cache controller 510 has to evict one of the existing entries in the L4 cache 110 memory elements, and the heuristic that the cache controller 510 uses to choose the entry to evict is called the replacement policy. The fundamental issue of any replacement policy is that it must predict which existing cache entry is least likely to be used in the future. So there are a variety of replacement policies to choose from and no perfect way to decide among them as understood by one skilled in the art. One popular replacement policy, LRU, replaces the least recently used entry. However, for the memory elements allocated as the MVCL buffer regions 505, these buffer regions 505 are not part of a replacement policy (of the cache controller 510) unlike the normal memory elements used for normal caching in the L4 cache 110. As such, the buffer regions 505 are not overwritten based on any replacement policy of the cache controller 510.

By the cache controller 510, location of an assigned MVCL buffer region 505 for a given processor 130 is determined by mapping the processor identification (ID) in the node 150 within the high order cache congruence class address bits, by using the lower portion of the cache congruence class for mapping the lines within the system page address, and keeping the MVCL buffer regions 505 all within the same cache associative set. Targeting the MVCL buffer regions to 1 associative set helps to reduce the logic in the cache controller 510 for locating the buffer regions 505.

Further, having the dedicated MVCL buffer regions 505 by (per) processor 130 simplifies resource management. For example, by cache controller 510 allocating each processor 130 its own 4 KB buffer region 505a, there are no resource management issues that restrict which processor 130 can write/buffer data and which processor 130 has to wait to write/buffer data. This is because each processor 130 has its own buffer region 505 which corresponds to the processor's ID.

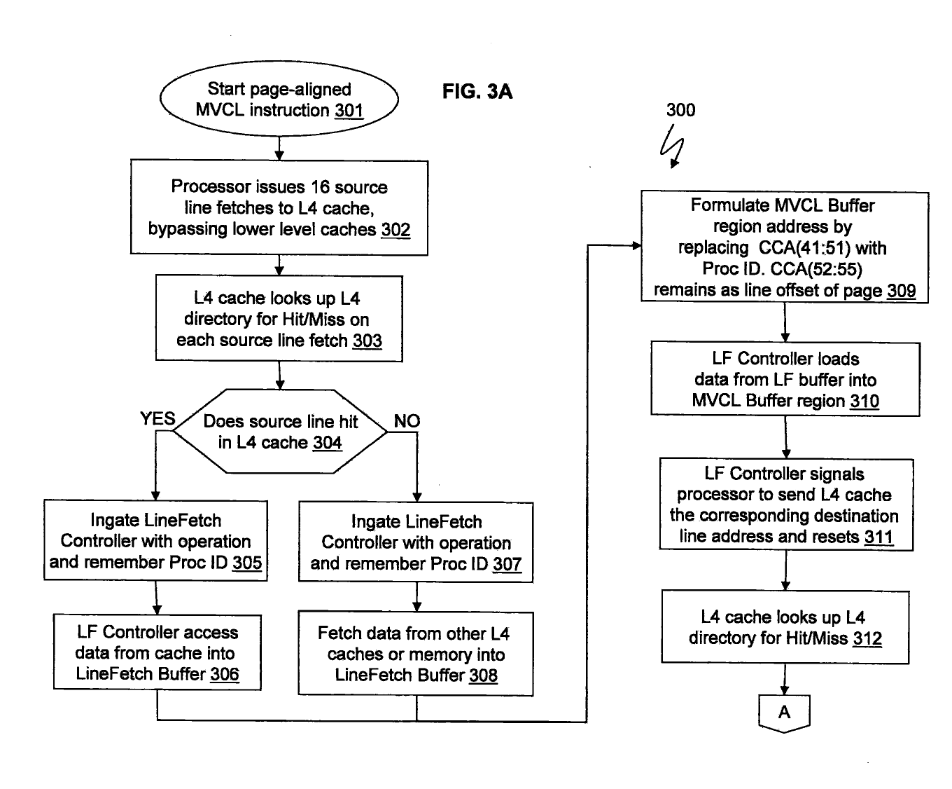

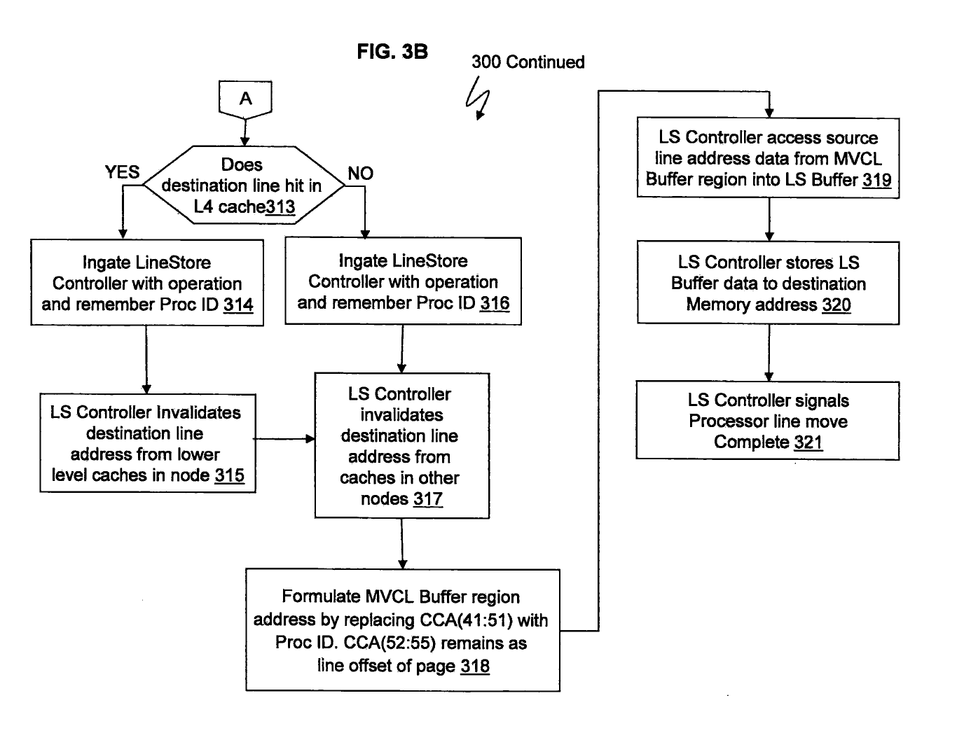

Also, the cache controller 510 is configured to control all operations of the L4 cache 110, which include cache operations discussed with reference to FIGS. 3A, 3B, 5, 6, and 7. Also, the cache controller 510 normally includes and/or represents controllers 706 and 710, and their respective data buffers 708 and 712 discussed below. Also, the cache controller 510 is configured to determine, designate, and assign the individual buffer regions 505 for each of the processors 130, along with reading (retrieving) and writing (storing) data to the buffer regions 505 (which are an allocated portion of the memory elements 520) and to the memory. Additionally, the cache controller 510 is configured to control and manage normal functions of the L4 cache 110 as understood by one skilled in the art.

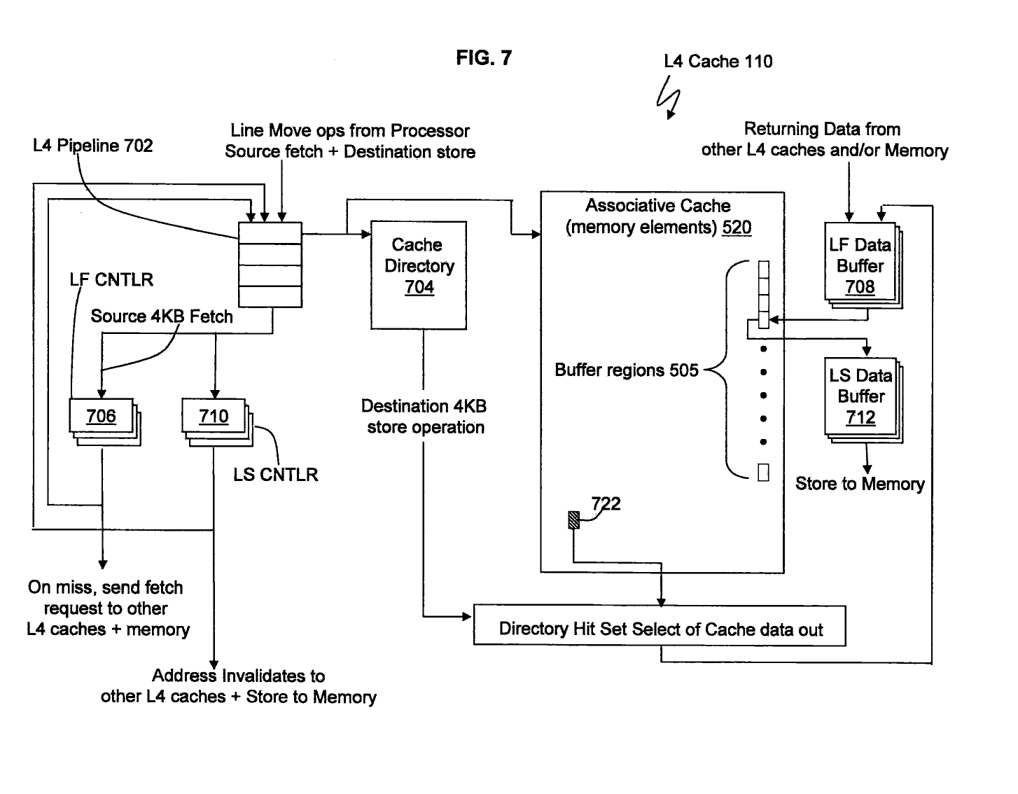

Now turning to FIGS. 3A and 3B, FIGS. 3A and 3B illustrate a flow 300 for moving data (such as storage data blocks) of MVCL instructions utilizing buffer regions 505 in accordance with exemplary embodiments. The flow 300 of FIGS. 3A and 3B will also be described with reference to FIG. 7. FIG. 7 illustrates address, control, and data flow in a high level cache (such as the L4 cache 110) in accordance with exemplary embodiments.

At operation 301, a program running on the processor 130 encounters a page-aligned MVCL instruction and breaks up the MVCL instruction into a series of separate 4 KB (page) move operations.

At operation 302, the processor 130 starts the 4 KB move by issuing 16 256 B-size line operations to the L4 cache chip 110 (also referred to as the System Controller (SC) chip) to bring in the 4 KB of the source page address.

At operation 303, as the L4 cache 110 (SC) receives each of the 16 source page line fetch operations, each of the 16 source page line fetch operations goes into the L4 pipeline 702 with each one separately to start processing; during the pipe pass the address is looked up in the local L4 cache directory 704 to determine if some of the data already exists in its L4 cache (i.e., the memory elements of the L4 cache used for normal caching).

At operation 304, the L4 cache 110 determines if the search for the source line (fetch operation) hits in L4 cache directory 704.

At operation 305, if yes it hits in the L4 cache 110, the source line fetch operation ingates (i.e., loads) or transfers into one of several or many LF (LineFetch) controllers 706 for continuation of processing which then recognizes the particular fetch operation and remembers the processor ID of the particular issuing processor 130. Each processor 130 in the node 150 has a unique processor ID.

At operation 306, the LF controller 706 makes a pipe pass of the L4 pipe 702 to read out the 256 B data block from the L4 hit cache slot and stores the data block into its dedicated 256 B LF buffer 708. As understood by one skilled in the art, the LF buffer 708 is not the discrete register file 420 and does not operate as the same. The LF buffer 708 is the normal buffer of a cache which stores data for a cache miss or MVCL fetch in the exemplary embodiment. For example, for the source line (fetch operation) hit in the L4 directory 704, the LF controller 706 reads out the 256 B data block, e.g., shown as block 722 of the memory elements 520.

At operation 307, if no hit because the source line look up in the L4 directory 704 was a miss, the source line fetch operation ingates (i.e., loads) or transfers into one of several or many LF (LineFetch) controllers 706 for continuation of processing which then recognizes the particular fetch operation and remembers the processor ID of the issuing processor 130.

At operation 308, on the miss, the LF controller 706 will send out a fetch of the source line address to other L4 caches in the system (e.g., on other nodes 150) and to the memory controller of the source line address. The data will then be sourced (retrieved) from the other cache on another node 150 that has a copy of the data or from the memory 415 if the data is not cached anywhere. When the data arrives it will be written into the LF buffer 708.

At operation 309, with the source line data now residing in the LF buffer 708, the LF controller 706 now determines the position/address of the MVCL buffer region 505 (assigned) to temporarily hold the source line data (for this particular issuing processor 130) until the corresponding destination line store operation starts processing. An individual MVCL buffer region 505a consists of 16 cache slots to match the 16 lines of a 4 KB page. The location of the particular MVCL buffer region 505a (out of all the MVCL buffer regions 505) is determined by concatenating the processor ID value (for the issuing processor 130) with the line address offset of the source page to form congruence class address bits 41:55 in a pre-determined associative set of L4 cache 110.

At operation 310, the LF controller 706 makes a pipe pass (of the L4 pipeline 702) to read out the 256 B data block from the LF buffer 708 and using the congruence class address determined from operation 309 to store the data block into the cache slot within to the processor's 130 own (individual) MVCL buffer region 505a. For example, the LF controller 706 may determine that the (address) buffer region for the particular processor 130 is the buffer region 505a, which is in part based on the particular processor's ID (which may be a numerical value and/or an alphanumerical value). When the memory elements 520 of the L4 cache 110 become available (or are not busy), the cache (LF) controller 510 loads the data from the LF buffer 708 into the memory elements 520 of the L4 cache 110.

At operation 311, after the source data is loaded into the MVCL buffer region 505a, the LF controller 706 then signals the processor 130 that the source line fetch is completed and the processor 130 can now proceed with issuing the destination line store operation to L4 cache 110 (SC). The LF controller 706 at this point resets and becomes available for another cache/memory fetch related operation.

At operation 312, as the L4 cache 110 (SC) receives a destination page line store operation from the same issuing processor 130, the destination page line store operation goes into the L4 pipeline 702 to start processing; during the pipe pass (of the L4 pipeline 702) the address is looked up in the local L4 cache directory 704 to determine if the destination line address already exists in the (memory elements 520) L4 cache 110, e.g., whether the destination page address is a hit or miss in the L4 cache directory 704.

At operation 313, the L4 cache 110 determines if the destination page line is a hit in the L4 cache directory 704.

At operation 314, if yes the destination page line is a hit in the L4 cache directory 704, the destination line store operation ingates (i.e., loads) or transfers into one of several or many LS (LineStore) controllers 710 for continuation of processing which then recognizes the particular store operation and remembers the processor ID of the issuing processor 130.

At operation 315, the LS controller 710 makes a pipe pass (through the L4 pipeline 702) to invalidate the lower level caches (such as the L3 cache 115, L2 cache 120, and L1 cache 125) on the same node 150 that have copies of the data belonging to the destination line address. This invalidation is necessary as the destination line address is about to be written with new data from the corresponding source line address.

At operation 316, if no the destination page line (address) is a miss in the L4 cache directory 704, the destination line store operation ingates (i.e., loads) or transfers into one of several or many LS (LineStore) controllers 710 for continuation of processing which then recognizes the particular store operation and remembers the processor ID of the issuing processor 130.

At operation 317, the LS controller 710 sends out an invalidation to the other nodes 150 to invalidate their copies of the data if the destination line address is found in their caches.

At operation 318, with the source line data residing in the processor's 130 own MVCL buffer region 505a as a result of the earlier source line fetch operation, the LS controller 710 now determines the position/address of the cache slot of the MVCL buffer region 505a by concatenating the processor ID value with the line address offset of the destination page to form congruence class address bits 41:55 in a pre-determined associative set of the L4 cache 410.

At operation 319, the LS controller 710 makes a pipe pass (through the L4 pipeline 702) to use the congruence class address determined at operation 318 to read out the 256 B data block from the MVCL buffer region 505a cache slot and stores the data into its dedicated LS buffer 712 to prepare for the storing into the memory 415.

At operation 320, the LS controller 710 sends data to the memory controller of the destination line address to write the data block into, e.g., memory 415 on the same node 150 as the L4 cache 110 or on a different node 150 in a multi-node symmetric multiprocessing (SMP) system.

At operation 321, after the new data is loaded into the memory 415, the LS controller 710 then signals the processor 130 that the destination line store is completed.

The processor 130 waits for all 16 of the destination line store operations to have been responded to by the L4 cache's LS controllers 710 before initiating the next 4 KB page move and/or end of instruction.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1. A computer implemented method for data buffering, the method comprising:
allocating a portion of a cache as buffer regions, wherein another portion of the cache is designated as random access memory (RAM);
assigning one of the buffer regions to a processor;
storing a data block to the one of the buffer regions of the cache according an instruction of the processor; and
storing the data block from the one of the buffer regions of the cache to the memory.

2. The method of claim 1, wherein storing the data block from the one of the buffer regions of the cache to the memory comprises moving the data block from the one of the buffer regions of the cache to the memory.

3. The method of claim 1, wherein the buffer regions and the random access memory are on a same cache.

4. The method of claim 1, further comprising restricting the portion of the cache allocated as the buffer regions from being utilized as the random access memory, such that the portion of the cache allocated as the buffer regions is not overwritten according to non-recently used rules for storing and overwriting data in the random access memory.

5. The method of claim 1, further comprising for a plurality of processors, each of the plurality of processors is respectively assigned to its own particular buffer region of the buffer regions;
wherein the buffer regions are configured such that each of the plurality of processors can simultaneously store a data block into its own particular buffer region without conflicts from another one of the plurality of processors.

6. The method of claim 1, further comprising determining an individual address assignment of the buffer regions to a plurality of processors, based on each processor identification (ID) of the plurality of processors.

7. The method of claim 1, wherein the portion of the cache allocated as the buffer regions is not part of a replacement policy and the portion of the cache allocated as the buffer regions is not overwritten based on the replacement policy; and
wherein the other portion of the cache designated as the random access memory is part of the replacement policy and the other portion of the cache is overwritten based on the replacement policy.

8. The method of claim 1, wherein respective ones of the buffer regions are individually assigned to respective processors, such that respective processors only store data to their respective ones of the buffer regions.

9. The method of claim 1, wherein the cache is closet to main memory.

10. A computer implemented method for data buffering, the method comprising:
allocating a portion of a cache as buffer regions, wherein another portion of the cache is designated as random access memory (RAM);
assigning processors to the buffer regions such that each processor is assigned to its own corresponding buffer region of the buffer regions;
simultaneously storing a data block to the corresponding buffer region for each of the processors of the cache according instructions of the processors; and
storing the data block from the corresponding buffer region of the cache for each of the processors to the memory.

11. The method of claim 10, wherein storing the data block from the corresponding buffer region of the buffer regions to the memory comprises moving the data block from the corresponding buffer region to the memory.

12. The method of claim 10, wherein the buffer regions and the random access memory are on a same cache.

13. The method of claim 10, further comprising restricting the portion of the cache allocated as the buffer regions from being utilized as the random access memory, such that the portion of the cache allocated as the buffer regions is not overwritten according to non-recently used rules for storing and overwriting data in the random access memory.

14. The method of claim 10, further comprising determining an individual address assignment of the buffer regions to the processors, based on each processor identification (ID) of the processors.

15. The method of claim 10, wherein the portion of the cache allocated as the buffer regions is not part of a replacement policy and the portion of the cache allocated as the buffer regions is not overwritten based on the replacement policy; and
wherein the other portion of the cache designated as the random access memory is part of the replacement policy and the other portion of the cache is overwritten based on the replacement policy.

16. The method of claim 1, wherein the processors are assigned such that each of the processors only stores data to its own corresponding buffer region.

17. The method of claim 1, wherein the cache is closet to main memory.
